(19) United States
(12) Patent Application Publication
(10) Pub. No.: US 2026/0180795 A1
(43) Pub. Date: Jun. 25, 2026

(54) METHOD, APPARATUS, SYSTEM, AND COMPUTER PROGRAM FOR AUTHENTICATED ENCRYPTION PROVIDING ENHANCED SECURITY AND NONCE LENGTH EXTENSION

(71) Applicant: SAMSUNG SDS CO., LTD., Seoul (KR)

(72) Inventors: Byeonghak LEE, Seoul (KR); Seongkwang KIM, Seoul (KR)

(73) Assignee: SAMSUNG SDS CO., LTD., Seoul (KR)

(21) Appl. No.: 19/389,970

(22) Filed: Nov. 14, 2025

(30) Foreign Application Priority Data
Dec. 19, 2024 (KR) 10-2024-0191119
Sep. 26, 2025 (KR) 10-2025-0139885

(51) Int. Cl. H04L 9/08; H04L 9/06; H04L 9/32

(52) U.S. Cl. CPC H04L 9/0869; H04L 9/0618; H04L 9/3242

(57) ABSTRACT

The present disclosure relates to an authenticated encryption method, apparatus, system, and computer program for providing enhanced security and extension of a nonce length, and more specifically, the present disclosure discloses a method for performing authenticated encryption using a computing apparatus, the method including: producing a plurality of intermediate values, based on a given input value; generating a random number, based on a combination of a plurality of intermediate random values produced by performing block cipher-based encoding on the plurality of intermediate values; and performing encryption or decryption, based on the random number.

### CROSS-REFERENCE TO RELATED APPLICATION(S)

This application is based on and claims priority under 35 U.S.C. 119 to Korean Patent Applications Nos. 10-2024-0191119 filed on Dec. 19, 2024 and 10-2025-0139885 filed on Sep. 26, 2025, in the Korean Intellectual Property Office, the disclosure of which is herein incorporated by reference in its entirety.

### BACKGROUND OF THE INVENTION

### 1. Field of the Invention

The present disclosure relates to an authenticated encryption method, apparatus, system, and computer program that provide enhanced security and extension of a nonce length and, more specifically, to an authenticated encryption method, apparatus, system, and computer program capable of extending a nonce length and providing enhanced security, based on a random number generation algorithm of an arbitrary output length.

### 2. Description of the Prior Art

As various online services have recently been widely provided based on wired and wireless communication networks, the importance of security has been continuously increasing.

In this regard, authenticated encryption (AE) is an encryption scheme that combines encryption and authentication in a single process to provide both confidentiality and integrity of data, and has the advantage of being more efficient than a case in which encryption and authentication are separately performed, and of being able to safely combine and provide separate encryption and authentication processes.

More specifically, standard algorithms such as CCM (Counter with CBC-MAC Mode), GCM (Galois/Counter Mode), AES-GCM-SIV (Advanced Encryption Standard-GCM-Synthetic Initialization Vector), and ChaCha20-poly1305 are used, and are widely used to ensure the security of modern communication protocols such as QUIC (Quick UDP Internet Connections), SSH (Secure Shell Protocol), and TLS (Transport Layer Security).

In addition, a nonce-based authenticated encryption (nAE) is the most popular authenticated encryption scheme, which can prevent a replay attack by receiving, as an additional input, a nonce, which is a value that changes each time encryption is performed, and in this case, if the nonce is reused, the security is no longer guaranteed.

Regarding this, in the case of nonce misuse resistant authenticated encryption (mrAE), a certain level of security may be provided even if the nonce is reused, but there may be a problem in that it is difficult to generate part of the ciphertext corresponding to a given part of the plaintext (online encryption), and the performance is also be degraded.

More specifically, GCM may be mentioned as the most widely used authenticated encryption (AE) scheme, and GCM has been adopted as a standard algorithm in NIST (SP800-38D) and ISO/IEC (19772:2020). In addition to this, OCB (Offset CodeBook mode), AES-GCM-SIV, and Chacha20-poly1305, etc., are also being utilized as standard algorithms.

However, most authenticated encryption (AE) schemes, including GCM, typically provide only the security level of 64 bits, resulting in insufficient security when handling large amounts of data, such as in cloud environments and large language model (LLM) training. This may lead to frequent key renewals and performance degradation of the entire system.

In addition, most authenticated encryption (AE) schemes, including GCM, have a limitation in that they are vulnerable to nonce misuse. More specifically, a 96-bit length is recommended as a nonce length in most authenticated encryption (AE) schemes, which may cause a problem that the uniqueness of the nonce is difficult to be guaranteed in an environment where encryption is frequently performed, and the nonce misuse resistant authenticated encryption (mrAE) may provide only low safety or may have low efficiency because key derivation is required each time encryption is performed.

In addition, in the case of an authenticated encryption (AE) scheme based on no block cipher, there is a nonce misuse resistant authenticated encryption (mrAE) with high security, such as Deoxys-II, but in this case, since it is not based on a block cipher, it is difficult to utilize a hardware accelerator such as AES-NI, which is widely used, and thus there could be a limitation in which it is difficult to ensure efficiency.

Accordingly, there is a continuing demand for authenticated encryption (AE) capable of extending the nonce length with high security and further suppressing nonce misuse, but an appropriate solution has not yet been proposed.

### SUMMARY OF THE INVENTION

The present disclosure has been made in order to solve the above-mentioned problems in the prior art and an aspect of the present disclosure is to provide an authenticated encryption method, device, system, and computer program capable of effectively prevent efficiency degradation and providing enhanced security while increasing the limit on the number of times encryption is performed by providing extension of a nonce length.

Another aspect of the present disclosure is to provide an authenticated encryption method, device, system, and computer program capable of effectively preventing nonce misuse while providing high security.

The technical problems to be solved by the present disclosure are not limited to those mentioned above, and other technical problems not specifically mentioned will be clearly understood by those skilled in the art from the description in the present specification.

In the first aspect of the present disclosure, there is provided a method for performing authenticated encryption using a computing apparatus, the method including: producing a plurality of intermediate values, based on a given input value;
generating a random number, based on a combination of a plurality of intermediate random values produced by performing block cipher-based encoding on the plurality of intermediate values; and performing encryption or decryption, based on the random number.

Here, in the generating of the random number, the random number may be generated based on a given nonce of arbitrary length, and in the performing of the encryption, ciphertext and tag for given plaintext may be produced based on the random number.

In addition, in the generating of the random number, the random number may be generated based on a given nonce of arbitrary length, and in the performing of the decryption, plaintext may be produced using given ciphertext and tag, based on the random number.

In addition, the generating of the random number may include: generating a preprocessed value having a predetermined length of 2n bits, based on a hash function for the nonce; generating a plurality of intermediate values, based on the preprocessed value; performing block cipher-based encoding on the plurality of intermediate values to produce a plurality of intermediate random values; and deriving a final random value, based on a combination of the plurality of intermediate random values.

In addition, the generating of the random number may include: producing a tag, based on a given nonce of arbitrary length; and producing the random number, based on the tag, and in the performing of the encryption, ciphertext for given plaintext may be produced based on the random number.

In addition, the producing of the tag may include: generating a preprocessed value having a predetermined length of 2n bits, based on a hash function for the nonce; generating a plurality of intermediate values, based on the preprocessed value; performing block cipher-based encoding on the plurality of intermediate values to produce a plurality of intermediate random values; and producing the tag, based on a combination of the plurality of intermediate random values.

In addition, the producing of the random number may include: generating a plurality of intermediate values, based on the tag; performing block cipher-based encoding on the plurality of intermediate values to produce a plurality of intermediate random values; and deriving a final random value, based on a combination of the plurality of intermediate random values.

In addition, in the generating of the random number, the random number may be generated based on a given tag, and the performing of the decryption may include: producing plaintext for given ciphertext, based on the random number; and performing authentication, based on a tag calculation value, produced based on the plaintext, and the tag.

In addition, the generating of the random number may include: generating a plurality of intermediate values, based on the tag; performing block cipher-based encoding on the plurality of intermediate values to produce a plurality of intermediate random values; and deriving a final random value, based on a combination of the plurality of intermediate random values.

In addition, the performing authentication may include: generating a preprocessed value having a predetermined length of 2n bits, based on a hash function for the nonce; generating a plurality of intermediate values, based on the preprocessed value; performing block cipher-based encoding on the plurality of intermediate values to produce a plurality of intermediate random values; and deriving the tag, based on a combination of the plurality of intermediate random values.

In addition, the generating of the random number may include: receiving, along with the input value of 2n bits, a length s of the final random value and an encryption key of k bits; calculating the number of blocks u corresponding to the final random value, based on blocks having the length of n bits; calculating the number of intermediate values v, based on u; and generating the v intermediate values, based on a first input value and a second input value obtained by dividing the input value into n-bit units.

In addition, in the producing of the intermediate random values, v intermediate random values may be produced by performing block cipher-based encoding on the v intermediate values.

In addition, the deriving may include: deriving the u random value blocks, based on a combination of the v intermediate random values; and deriving a final random value having a length of s, based on the u random value blocks.

In addition, in the deriving of the final random value, the final random value may be derived by extracting bits having the length of s from a random value derived by concatenating the u random value blocks.

In addition, the generating of the random number may include generating the input value having a predetermined length of 2n bits, based on a hash function, by preprocessing an unprocessed input value of arbitrary length.

In addition, the preprocessing may include: producing a first hash output value and a second hash output value by inputting the unprocessed input value, and a first hash key and a second hash key, which are different from each other, to a first hash function configured to generate an n-bit output; performing block cipher-based encoding on the first hash output value and the second hash output value to produce a first hash random value and a second hash random value; and generating the input value having a length of 2n bits by concatenating the first hash random value and the second hash random value.

In the second aspect of the present disclosure, there is provided an apparatus for performing authenticated encryption, which includes a processor; and a memory, wherein the memory may store instructions configured to cause, when executed by the processor, the apparatus to perform specific operations, the specific operations including: producing a plurality of intermediate values, based on a given input value; generating a random number, based on a combination of a plurality of intermediate random values produced by performing block cipher-based encoding on the plurality of intermediate values; and performing encryption or decryption, based on the random number.

In the third aspect of the present disclosure, there is provided a computer-readable storage medium that stores instructions configured to cause, when executed by a processor, an apparatus, including the processor and performing authenticated encryption, to perform specific operations, wherein the specific operations may include: producing a plurality of intermediate values, based on a given input value; generating a random number, based on a combination of a plurality of intermediate random values produced by performing block cipher-based encoding on the plurality of intermediate values; and performing encryption or decryption, based on the random number.

Accordingly, the authenticated encryption method, apparatus, system, and computer program, providing enhanced security and extension of a nonce length, according to an embodiment of the present disclosure are capable of effectively preventing efficiency degradation and providing enhanced security while increasing the limit on the number of times encryption is performed by providing extension of a nonce length.

Furthermore, the authenticated encryption method, apparatus, system, and computer program, providing enhanced security and extension of a nonce length, according to an embodiment of the present disclosure are capable of effectively preventing nonce misuse while providing high security.

Furthermore, the authenticated encryption method, apparatus, system, and computer program, providing enhanced security and extension of a nonce length, according to an embodiment of the present disclosure are capable of improve usability by reducing the need for key renewal and further providing a nonce length extension or nonce misuse prevention function, thereby effectively reducing the additional management work and costs required to prevent nonce misuse.

The effects obtainable from the present disclosure are not limited to those mentioned above, and other unmentioned effects will be clearly understood by those skilled in the art to which the present disclosure pertains from the description herein.

### BRIEF DESCRIPTION OF THE DRAWINGS

The accompanying drawings, which are included as part of the detailed description to aid in the understanding of the present disclosure, illustrate embodiments of the present disclosure and, together with the detailed description, serve to explain the technical concept of the present disclosure.

FIG. 1 is a diagram illustrating the configuration of an authenticated encryption system according to an embodiment of the present disclosure.

FIG. 2 is a flowchart illustrating an authenticated encryption method according to an embodiment of the present disclosure.

FIG. 3 is a diagram illustrating the detailed configuration and operation of an authenticated encryption apparatus (embodiment 1-1) according to an embodiment of the present disclosure.

FIG. 4 is a flowchart specifically illustrating an authenticated encryption apparatus (embodiment 1-1) according to an embodiment of the present disclosure.

FIG. 5 is a diagram illustrating the detailed configuration and operation of an authenticated encryption apparatus (embodiment 1-2) according to an embodiment of the present disclosure.

FIG. 6 is a diagram illustrating the detailed configuration and operation of an authenticated encryption apparatus (embodiment 2-1) according to an embodiment of the present disclosure.

FIGS. 7 to 9 are flowcharts specifically illustrating the operation of an authenticated encryption apparatus (embodiment 2-1) according to an embodiment of the present disclosure.

FIG. 10 is a diagram illustrating the detailed configuration and operation of an authenticated encryption apparatus (embodiment 2-2) according to an embodiment of the present disclosure.

FIGS. 11 to 13 are flowcharts specifically illustrating the operation of an authenticated encryption apparatus (embodiment 2-2) according to an embodiment of the present disclosure.

FIGS. 14 to 21 are diagrams illustrating the detailed configuration and operation of a first pseudo-random number function and a second pseudo-random number function according to an embodiment of the present disclosure.

FIG. 22 is a diagram illustrating the configuration of an apparatus for performing authenticated encryption according to an embodiment of the present disclosure.

### DETAILED DESCRIPTION OF THE EXEMPLARY EMBODIMENTS

Hereinafter, embodiments disclosed in the present specification will be described in detail with reference to the accompanying drawings. The purpose, specific advantages, and novel features of the present disclosure will become more apparent from the following detailed description and preferred embodiments associated with the attached drawings.

Prior to the description, the terms and words used in the present specification and claims, which are appropriately defined by the inventor to best describe the invention, should be interpreted as meanings and concepts consistent with the technical idea of the present disclosure, and are intended only for the purpose of describing exemplary embodiments, and should not be construed as limiting the present disclosure.

Identical or similar components will be assigned the same reference numerals, regardless of the reference numerals, and redundant descriptions thereof will be omitted. The terms “module” and “unit” used for components in the following description are assigned or used interchangeably only in consideration of the ease of drafting the specification, and do not have distinct meanings or roles in themselves, which may indicate software or hardware components.

In describing the components of the disclosure, singular expressions should be understood to encompass a plurality of components unless specifically stated otherwise. In addition, although the terms “first,” “second,” etc. are used to distinguish one component from another component, components are not limited to these terms. In addition, the case where a component is connected to another component may indicate that another component may be connected between the two components.

In addition, when describing the embodiments disclosed in this specification, a specific description of a related known technology, which may obscure the subject matter of the embodiments disclosed in this specification, will be omitted. In addition, the attached drawings are only intended to facilitate easy understanding of the embodiments disclosed in this specification, and the technical concepts disclosed in this specification are not limited to the attached drawings, and should be understood to encompass all modifications, equivalents, or substitutes included in the concepts and scope of the disclosure.

Hereinafter, exemplary embodiments of an authenticated encryption method, apparatus, system, and computer program, which provide enhanced security and extension of a nonce length, according to the present disclosure will be described in detail with reference to the accompanying drawings.

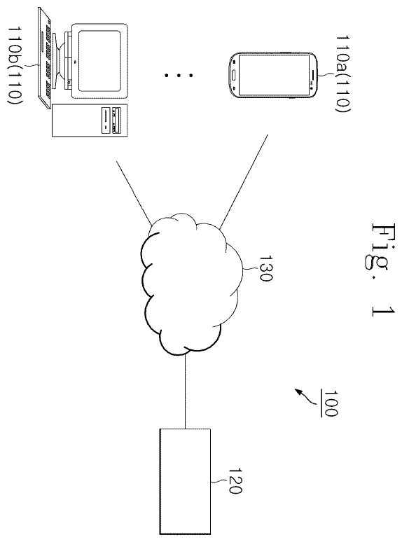

First, FIG. 1 illustrates the configuration and operation of an authenticated encryption system 100 according to an embodiment of the present disclosure. As shown in FIG. 1, an authenticated encryption system 100 according to an embodiment of the present disclosure may include one or more terminals 110 and an authenticated encryption apparatus 120 that performs authenticated encryption in conjunction with the one or more terminals 110.

In this case, the terminal 110 may request the authenticated encryption apparatus 120 to perform authenticated encryption (AE) or request an application that utilizes authenticated encryption therefrom, and may perform various functions, such as providing services to users, based on the same.

Here, the terminal 110 may be a variety of terminals capable of participating in the authenticated encryption process, such as a personal computer (PC), laptop PC, tablet PC, smartphone, or PDA, but the present disclosure is not necessarily limited thereto, and various other apparatuses may be used as the terminal 110.

In addition, the authenticated encryption apparatus 120 may be an apparatus that performs authenticated encryption while operating independently or in conjunction with the terminal 110.

Here, although the authenticated encryption apparatus 120 may be implemented using one or more physical servers, the present disclosure is not necessarily limited thereto, and may be further implemented in various forms, such as network apparatuses such as repeaters, hubs, bridges, switches, routers, and gateways, home appliances such as digital TVs, personal terminals, or even as dedicated apparatuses.

Furthermore, the terminal 110 and the authenticated encryption apparatus 120 may be implemented in various forms, such as being combined into a single physical apparatus.

Additionally, a communication network 130 connecting the terminal 110 and the authenticated encryption apparatus 120 in FIG. 1 may be a wired network or a wireless network, and specifically, may include various communication networks such as a Local Area Network (LAN), a Metropolitan Area Network (MAN), and a Wide Area Network (WAN). In addition, the communication network 130 may also include the well-known World Wide Web (WWW). Furthermore, the communication network 130 may be implemented using a data bus configured to transmit and receive data, etc.

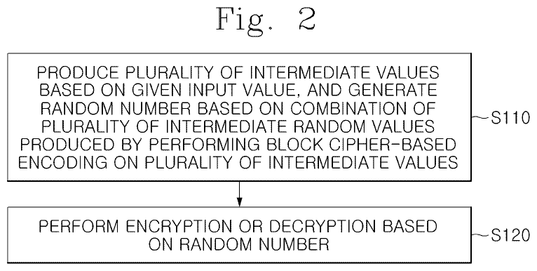

In addition, FIG. 2 is a flowchart illustrating an authenticated encryption method according to an embodiment of the present disclosure.

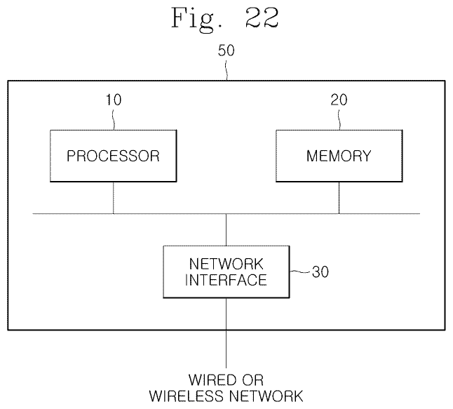

Here, the method illustrated in FIG. 2 may be performed, for example, by the authenticated encryption apparatus 120 in FIG. 1. Furthermore, the authenticated encryption apparatus 120 may be implemented using the computing apparatus 50 in FIG. 22 and the description made below with reference to FIG. 22. For example, the computing apparatus 50 may include a processor 10, and the processor 10 may execute instructions configured to perform operations for performing authenticated encryption.

More specifically, as shown in FIG. 2, the authenticated encryption method according to an embodiment of the present disclosure is a method for performing authenticated encryption using the computing apparatus 50, and may include an operation S110 of producing a plurality of intermediate values, based on a given input value, and generating a random number, based on a combination of a plurality of intermediate random values produced by performing block cipher-based encoding on the plurality of intermediate values, and an operation S120 of performing encryption or decryption, based on the random number.

Here, in the generating operation S110, the random number may be generated based on a given nonce of arbitrary length, and in the performing operation S120, the ciphertext and tag for the given plaintext may be produced based on the random number.

Additionally, in the generating operation S110, the random number may be generated based on a given nonce of arbitrary length, and in the performing operation S120, the plaintext may be produced using the given ciphertext and tag, based on the random number.

In addition, the generating operation S110 may include an operation S111 of generating a preprocessed value having a predetermined length of 2n bits, based on a hash function for the nonce, an operation S112 of generating a plurality of intermediate values, based on the preprocessed value, an operation S113 of performing block cipher-based encoding on the plurality of intermediate values to produce a plurality of intermediate random values, and an operation S114 of deriving a final random value, based on a combination of the plurality of intermediate random values.

Additionally, the generating operation S110 may include an operation S115 of producing a tag, based on a given nonce of arbitrary length, and an operation S116 of producing the random number on the basis of the tag, and in the performing operation S120, ciphertext for the given plaintext may be produced based on the random number.

Furthermore, the operation S115 of producing the tag may include an operation S1151 of generating a preprocessed value having a predetermined length of 2n bits, based on a hash function for the nonce, an operation S1152 of generating a plurality of intermediate values, based on the preprocessed value, an operation S1153 of performing block cipher-based encoding on the plurality of intermediate values to produce a plurality of intermediate random values, and an operation S1154 of producing the tag on the basis of a combination of the plurality of intermediate random values.

Additionally, the operation S116 of producing the random number may include an operation S1161 of generating a plurality of intermediate values on the basis of the tag, an operation S1162 of performing block cipher-based encoding on the plurality of intermediate values to produce a plurality of intermediate random values, and an operation S1163 of deriving a final random value on the basis of a combination of the plurality of intermediate random values.

Furthermore, in the generating operation S110, the random number may be generated based on a given tag, and the performing operation S120 may include an operation S121 of producing the plaintext for the given ciphertext, based on the random number, and an operation S122 of performing authentication, based on the tag calculation value, produced on the basis of the plaintext, and the tag.

Additionally, the generating operation S110 may include an operation S110a of generating a plurality of intermediate values, based on the tag, an operation S110b of performing block cipher-based encoding on the plurality of intermediate values to produce a plurality of intermediate random values, and an operation S110c of deriving a final random value, based on a combination of the plurality of intermediate random values.

Furthermore, the operation S122 of performing authentication may include an operation S1221 of generating a preprocessed value having a predetermined length of 2n bits, based on a hash function for the nonce, an operation S1222 of generating a plurality of intermediate values, based on the preprocessed value, an operation S1223 of performing block cipher-based encoding on the plurality of intermediate values to produce a plurality of intermediate random values, and an operation S1224 of deriving the tag, based on a combination of the plurality of intermediate random values.

At this time, the generating operation S110 may include an operation S210 of receiving the final random value length s and a k-bit encryption key along with the 2n-bit input value, an operation S220 of calculating the number of blocks u corresponding to the final random value, based on blocks having a length of n bits, an operation S230 of calculating the number of intermediate values v, based on u, and an operation S240 of generating v intermediate values, based on a first input value and a second input value obtained by dividing the input value into n-bit units.

Additionally, in the producing operation S1223, v intermediate random values may be produced by performing block cipher-based encoding on the v intermediate values.

Additionally, the derivation operation S1224 may include an operation (not shown) of deriving u random value blocks, based on a combination of the v intermediate random values, and a final-random value derivation operation (not shown) of deriving a final random value having a length of s, based on the u random value blocks.

Furthermore, in the final-random value derivation operation (not shown), the final random value may be derived by extracting the bits having the length of s from the random value derived by concatenating the u random value blocks.

Furthermore, the generation operation S110 may include a length preprocessing operation (not shown) of generating the input value having a predetermined length of 2n bits, based on a hash function for an unprocessed input value of arbitrary length.

In addition, the length preprocessing operation (not shown) may include an operation S410 of inputting the unprocessed input value and a first hash key and a second hash key, which are different from each other, to a first hash function that generates an output of n bits to generate a first hash output value and a second hash output value, an operation S420 of performing block cipher-based encoding on the first hash output value and the second hash output value to produce a first hash random value and a second hash random value, and an operation S430 of generating the input value having a length of 2n bits by concatenating the first hash random value and the second hash random value.

Accordingly, the authenticated encryption method, apparatus, system, and computer program, providing enhanced security and extension of a nonce length, according to an embodiment of the present disclosure may provide extension of a nonce length to effectively prevent efficiency degradation and provide enhanced security while increasing the limit on the number of times encryption is performed, may effectively suppress nonce misuse while providing high security, may improve usability by reducing the need for key renewal, and may further provide nonce length extension or nonce misuse suppression functions, thereby effectively reducing additional management work and costs that may be required to prevent nonce misuse.

Hereinafter, the configuration and operation of an authenticated encryption method, apparatus, and system, providing enhanced security and extension of a nonce length, according to an embodiment of the present disclosure will be described in more detail with reference to the respective drawings.

First, in operation S110, a computing apparatus 50, such as an authenticated encryption apparatus 120, produces a plurality of intermediate values, based on a given input value, and generates a random number based on a combination of a plurality of intermediate random values produced by performing block cipher-based encoding on the plurality of intermediate values.

Here, in the present disclosure, the term “random number” may be used in a comprehensive sense, including a pseudo-random number.

More specifically, in the present disclosure, the authenticated encryption apparatus 120 may generate a random number, based on a given input value, using a pseudo-random number function (PRF), such as a variable output length pseudo-random number function (VOL-PRF) capable of generating a random number having an arbitrary output length. In this case, the pseudo-random number function may produce a plurality of intermediate values, based on the given input value, and generate a random number, based on a combination of a plurality of intermediate random values produced by performing block cipher-based encoding on the plurality of intermediate values.

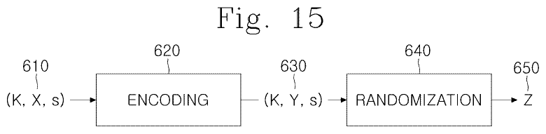

For a more specific example, as shown in FIG. 15, the pseudo-random number function (PRF) may be configured to include an encoding unit 620 and a randomization unit 640 (hereinafter, the first pseudo-random number function in FIG. 15 will be referred to as “eCTR”), wherein the encoding unit 620 may generate a plurality of intermediate values Y, based on an input 610 including an encryption key K of a block cipher, an input value X for generating a pseudo-random number, and a length s of a final random value ultimately obtained, and may provide an output 630 including the encryption key K of the block cipher and the length s of the final random value to the randomization unit 640. Subsequently, the randomization unit 640 may derive a final random value Z 650 having a length s through a block cipher-based operation.

Here, the block cipher is an element technology that encrypts/decrypts confidential information in units of blocks, and may be configured, when a key set is a set of k-bit strings and a block is an n-bit string, as an encryption algorithm E:{0,1}^{k}×{0,1}ⁿ→{0,1}ⁿ and a decryption algorithm D:{0,1}^{k}×{0,1}ⁿ→{0,1}, so that for any K∈{0,1}^{k}, M∈{0,1}ⁿ, D(K,E(K,M))=M is satisfied.

At this time, the block cipher must satisfy pseudo-random-permutation security, that is, no efficient adversary is able to distinguish E(K, ⋅) for a random k-bit string K from a permutation on an arbitrary {0,1}ⁿ.

Furthermore, when a key K is randomly selected from the key space [symbol] for a keyed function H: [symbol] ×X→ [symbol] , any distinct X,X′∈X, and any Y∈ [symbol] , if Pr[H(K,X)⊕H(K,X′)=Y]≤δ, H is called a δ-Almost XOR Universal (δ-AXU) hash function.

Furthermore, if H satisfies Pr[H(K,X)=Y]≤δ′ in the same situation, H is called a δ-Almost Uniform (δ-AU) hash function.

In this case, AU and AXU may be configured using polynomial-based hashes (Ghash or PolyHash) or block cipher-based hashes (PHash or CBC-Hash), which are more efficient than conventional cryptographic hashes, and may be configured as simple polynomial operations such as PolyHash(K, X₁∥X₂∥ . . . ∥Xₘ)=K·X₁+K²·X₂+ . . . +K^{m}·Xₘ(where K, X₁, . . . ,Xₘ are all elements of the Galois field GF(2ⁿ)).

Here, the parameters and components related to the first pseudo-random number function (=eCTR) are summarized as follows.
k: Bit length of a base block cipher.
n: Block bit length of a base block cipher.
w: Window parameter, which is a natural number used in the algorithm's operation.
E Base block cipher, which is not used in decryption, and E(K,M) represents the result of encrypting an n-bit block M with a k-bit key K.
GF(2ⁿ): Galois field with 2ⁿ elements. GF(2ⁿ) is defined as GF(2)/F(W) for an n-th order primitive polynomial F(W), where W may be represented as 2.

Accordingly, the first pseudo-random number function (eCTR) may receive a k-bit key, a 2n-bit input value X, and an output bit length s (a natural number) as input, and output an s-bit string Z. Here, the first pseudo-random number function (eCTR) is a variable output length pseudo-random number function, and may achieve n-bit level security based on an n-bit block cipher.

Furthermore, the present disclosure may extend the pseudo-random number function (PRF) to receive an input of arbitrary length and generate a pseudo-random number having an arbitrary output length, and may also generate a random number, based on this, to perform authenticated encryption.

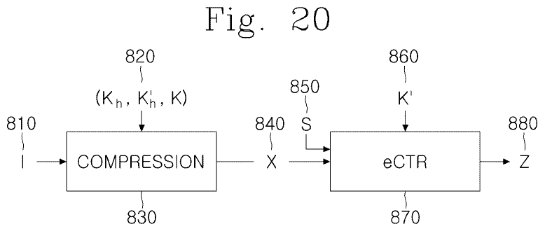

More specifically, referring to FIG. 20, the pseudo-random number function (PRF) may include a compression unit 830 that generates a preprocessed value having a predetermined length of 2n bits, based on a hash function for an unprocessed input value having an arbitrary length, and a random number generation unit 870 (=eCTR) that generates a random number, based on the preprocessed value (hereinafter, the second pseudo-random number function in FIG. 20 will be referred to as “HteC”).

Here, the parameters and components related to the second pseudo-random number function (=HteC) are summarized as follows.
k: Key bit length of a base block cipher.
n: Block bit length of a base block cipher.
w: Window parameter, a natural number used in the operation of the algorithm.
E: Base block cipher, which is not used in decryption, and E(K,M) represents the result of encrypting an n-bit block M with a k-bit key K.
H: Keyed function that has an element of [symbol] as a key, and receives an arbitrary-length bit string as input, and outputs an n-bit output.
GF(2ⁿ): Galois field with 2ⁿ elements. GF(2ⁿ) is defined as GF(2)/F(W) for an n-th order primitive polynomial F(W), where W may be represented as 2.

Accordingly, the second pseudo-random number function (=HteC) may receive, as input, hash keys

$${K}_{h} , {K}_{h}^{′} ∈ 𝒦 ,$$

k-bit keys K,K′, an input string I of arbitrary-length bits, and an output bit length s (a natural number), and output an s-bit string Z. Here, the second pseudo-random number function (=HteC) is a variable output length pseudo-random number function, and may achieve n-bit level security based on an n-bit block cipher.

In this regard, the more specific configuration and operation of the first pseudo-random number function (=eCTR) and the second pseudo-random number function (=HteC) will be described in detail later.

Next, in operation S120, the computing apparatus 50, such as the authenticated encryption apparatus 120, performs encryption or decryption on the basis of the generated random number.

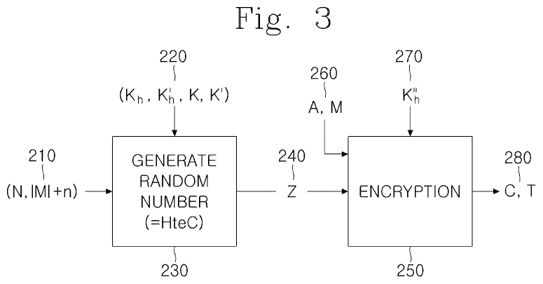

In this regard, FIG. 3 illustrates a configuration in which the authenticated encryption apparatus 120 performs encryption using the second pseudo-random number function (=HteC) (=embodiment 1-1).

More specifically, as shown in FIG. 3, the authenticated encryption apparatus 120 may be configured to include a random number generation unit 230 and an encryption unit 250 (hereinafter, the 1-1st authenticated encryption unit in FIG. 3 will be referred to as “eGCM-1”).

For example, the 1-1st authenticated encryption unit (=eGCM-1) may implement authenticated encryption, based on GCM, by replacing the CTR block with the second pseudo-random number function (=HteC), thereby enhancing security without compromising efficiency. However, the present disclosure is not necessarily limited thereto, and it may be implemented in various other structures.

Accordingly, while GCM has n/2-bit security when based on an n-bit block cipher, the 1-1st authenticated encryption unit (=eGCM-1) may have n-bit security, and overcome the nonce and output length limitations of GCM by utilizing a variable input/output length pseudo-random number function.

More specifically, referring to FIG. 3, the 1-1st authenticated encryption unit (=eGCM-1) may generate a random number (Z of 240 in FIG. 3), based on a given nonce of arbitrary length (N of 210 in FIG. 3) in the operation S110, and then produce ciphertext (C of 280 in FIG. 3) and tag (T of 280 in FIG. 3) for given plaintext (M of 260 in FIG. 3), based on the random number (Z of 240 in FIG. 3), in the operation S120.

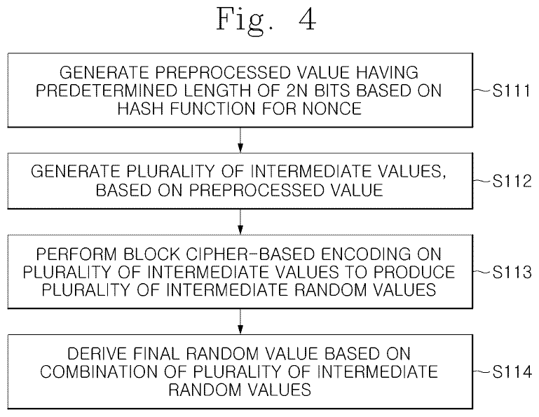

More specifically, in the 1-1st authenticated encryption unit (eGCM-1), the operation S110 may include, as shown in FIG. 4, an operation S111 of generating a preprocessed value having a predetermined length of 2n bits, based on a hash function for the nonce, an operation S112 of generating a plurality of intermediate values, based on the preprocessed value, an operation S113 of performing block cipher-based encoding on the plurality of intermediate values to produce a plurality of intermediate random values, and an operation S114 of producing the tag, based on a combination of the plurality of intermediate random values.

Here, the parameters and components related to the 1-1st authenticated encryption unit (=eGCM-1) are summarized as follows.
k: Key bit length of a base block cipher.
n: Block bit length of a base block cipher.
w: Window parameter, a natural number used in the operation of the algorithm.
E: Base block cipher, which is not used in decryption, and E(K,M) represents the result of encrypting an n-bit block M with a k-bit key K.
H: Keyed function that has an element of [symbol] as a key, and receives an arbitrary-length bit string as input, and outputs an n-bit output.
GF(2ⁿ): Galois field with 2ⁿ elements. GF(2ⁿ) is defined as GF(2)/F(W) for an n-th order primitive polynomial F(W), where W may be represented as 2.
τ: Tag bit length.

Accordingly, the 1-1st authenticated encryption unit (=eGCM-1) may receive, as input, hash keys

$${K}_{h} , {K}_{h}^{′} , {K}_{h}^{″} ∈ K ,$$

k-bit keys K,K′, a nonce N of arbitrary bit length, plaintext M of arbitrary bit length, and associated data A of arbitrary bit length, and output ciphertext C and tag T.

Here, the associated data (AD) is data used for authentication along with the encrypted message but is not encrypted. Therefore, the associated data may be transmitted unencrypted and used to verify integrity and authentication.

More specifically, in the 1-1st authenticated encryption unit (=eGCM-1), the random number generation unit 230 may produce an output Z as shown in Equation 1 below.

$$Z = HteC ( ( {K}_{h} , {K}_{h}^{′} , K , {K}^{′} ) , N , \vert M \vert + n ) \qquad [ Equation 1 ]$$

Next, the encryption unit 250 may divide the output Z of the random number generation unit 230 into the first n-bit Z₀ and the remainder Z₁, as shown in Equation 2 below.

$${Z}_{0} ‖ {Z}_{1} = Z ( \vert {Z}_{0} \vert = n , \vert {Z}_{1} \vert = \vert M \vert ) \qquad [ Equation 2 ]$$

Furthermore, the encryption unit 250 may generate the ciphertext C by adding the plaintext M and Z₁, as shown in Equation 3 below.

$$C = M ⊕ {Z}_{1} \qquad [ Equation 3 ]$$

Furthermore, the encryption unit 250 may hash the associated data A and ciphertext C, add Z₀, and truncate the data by i-bits to generate a tag T, as shown in Equation 4 below.

$$T = {Truncate}_{τ} ( H ( {K}_{h}^{″} , ( A , C ) ) ⊕ {Z}_{0} ) \qquad [ Equation 4 ]$$

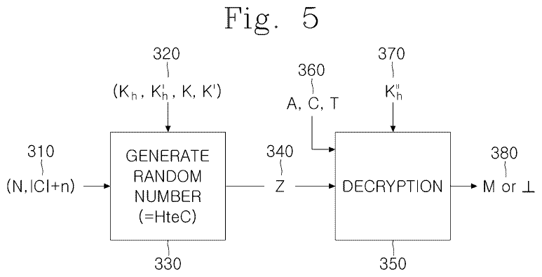

In this regard, FIG. 5 illustrates a configuration in which the authenticated encryption apparatus 120 performs decryption using the second pseudo-random number function (=HteC) (=embodiment 1-2).

More specifically, as shown in FIG. 5, the authenticated encryption apparatus 120 may be configured to include a random number generation unit 330 and a decryption unit 350 (hereinafter, the 1-2nd authentication decryption unit in FIG. 5 will be referred to as “eGCM-2”).

For example, the 1-2nd authentication decryption unit (=eGCM-2) may implement authenticated encryption, based on GCM, by replacing the CTR block with the second pseudo-random number function (=HteC), thereby enhancing security without compromising efficiency. However, the present disclosure is not necessarily limited thereto, and it may be implemented in various other structures.

More specifically, referring to FIG. 5, the 1-2nd authentication decryption unit (=eGCM-2) may generate a random number (Z of 340 in FIG. 5), based on a given nonce of arbitrary length (N of 310 in FIG. 5) in the operation S110, and then produce plaintext (M of 380 in FIG. 5) using the given ciphertext (C of 360 in FIG. 5) and tag (T of 360 in FIG. 5), based on the random number (Z of 340 in FIG. 5), in the operation S120.

More specifically, in the 1-2nd authentication decryption unit (=eGCM-2), the operation S110 may include, as described with reference to FIG. 4 above, an operation S111 of generating a preprocessed value having a predetermined length of 2n bits, based on a hash function for the nonce, an operation S112 of generating a plurality of intermediate values, based on the preprocessed value, an operation S113 of performing block cipher-based encoding on the plurality of intermediate values to produce a plurality of intermediate random values, and an operation S114 of producing the tag, based on a combination of the plurality of intermediate random values.

Additionally, the parameters and components related to the 1-2nd authentication decryption unit (=eGCM-2) may refer to those of the 1-1st authenticated encryption unit (=eGCM-1) described above.

Accordingly, the 1-2nd authentication decryption unit (=eGCM-2) may receive, as input, hash keys

$${K}_{h} , {K}_{h}^{′} , {K}_{h}^{″} ∈ K ,$$

k-bit keys K,K′, a nonce N of arbitrary bit length, ciphertext C of arbitrary bit length, and associated data A of arbitrary bit length, and output plaintext M when authentication is successful, or ⊥ (authentication failure symbol) when authentication fails.

More specifically, in the 1-2nd authentication decryption unit (=eGCM-2), the random number generation unit 230 may produce an output Z, as shown in Equation 5 below.

$$Z = HteC ( ( {K}_{h} , {K}_{h}^{′} , K , {K}^{′} ) , N , \vert C \vert + n ) \qquad [ Equation 5 ]$$

Next, the decryption unit 370 may divide the output Z of the random number generation unit 230 into the first n-bit Z₀ and the remainder Z₁, as shown in Equation 6 below.

$${Z}_{0} ‖ {Z}_{1} = Z ( \vert {Z}_{0} \vert = n , \vert {Z}_{1} \vert = \vert C \vert ) \qquad [ Equation 6 ]$$

Furthermore, the decryption unit 370 may generate the plaintext M by adding the ciphertext C and Z₁, as shown in Equation 7 below.

$$M = C ⊕ {Z}_{1} \qquad [ Equation 7 ]$$

Furthermore, the decryption unit 370 may hash the associated data A and ciphertext C, add Z₀, and truncate the data by i-bits to produce a tag T′, as shown in Equation 8 below.

$${T}^{′} = {Truncate}_{τ} ( H ( {K}_{h}^{″} , ( A , C ) ) ⊕ {Z}_{0} ) \qquad [ Equation 8 ]$$

Accordingly, the 1-2nd authentication decryption unit (=eGCM-2) may output a message M when the produced tag T′ and the given tag T are identical, and output an authentication failure symbol (⊥) when they are different.

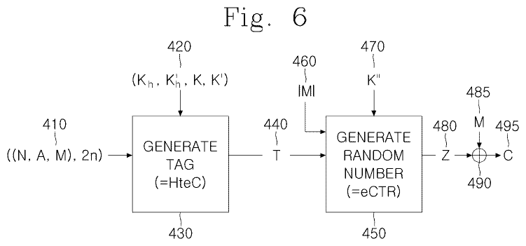

Additionally, FIG. 6 illustrates a configuration in which the authenticated encryption apparatus 120 generates a tag using the second pseudo-random number function (=HteC) and generates a random number using the first pseudo-random number function (=eCTR), thereby performing encryption (=embodiment 2-1).

More specifically, as shown in FIG. 6, the authenticated encryption apparatus 120 may be configured to include a tag generation unit 430 and a random number generation unit 450 (hereinafter, the 2-1st authenticated encryption unit in FIG. 6 will be referred to as “eGCM-SIV-1”).

For example, the 2-1st authenticated encryption unit (=eGCM-SIV-1) may implement authenticated encryption, based on GCM-SIV, by generating a tag using the second pseudo-random number function (=HteC) and replacing the CTR block with the first pseudo-random number function (=eCTR), thereby enhancing security without compromising efficiency. However, the present disclosure is not necessarily limited thereto, and it may be implemented in various other structures.

Accordingly, when based on an n-bit block cipher, GCM-SIV has n/2-bit security, but the 2-1st authenticated encryption unit (=eGCM-SIV-1) may have n-bit security and may also overcome the output length limitation of GCM-SIV. Furthermore, the 2-1st authentication encryption unit (eGCM-SIV-1) may exhibit a slight decrease in efficiency compared to GCM-SIV, as the number of hash computations for the input increases from once to twice. However, since hash functions are generally faster to compute than block ciphers, it becomes possible to minimize the efficiency degradation.

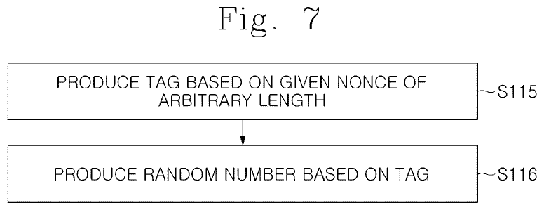

Here, in the 2-1st authenticated encryption unit (=eGCM-SIV-1), the operation S110 may include, as shown in FIG. 7, an operation S115 of producing a tag, based on a given nonce of arbitrary length, and an operation S116 of producing the random number on the basis of the tag, and in the operation S120, ciphertext for the given plaintext may be produced based on the random number.

More specifically, referring to FIG. 6, in the 2-1st authenticated encryption unit (=eGCM-SIV-1), a tag (T of 440 in FIG. 6) may be produced based on a given nonce (N of 410 in FIG. 6) of arbitrary length in the operation S115, and the random number (Z of 480 in FIG. 6) may be produced based on the tag (T of 440 in FIG. 6) in the operation S116, and then, in operation S120, the ciphertext (C of 495 in FIG. 6) for the given plaintext (M of 485 in FIG. 6) may be produced based on the random number (Z of 480 in FIG. 6).

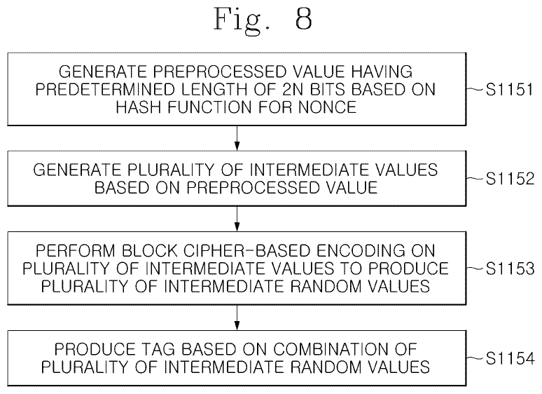

Here, in the 2-1st authenticated encryption unit (=eGCM-SIV-1), the operation S115 may include, as shown in FIG. 8, an operation S1151 of generating a preprocessed value having a predetermined length of 2n bits, based on a hash function for the nonce, an operation S1152 of generating a plurality of intermediate values, based on the preprocessed value, an operation S1153 of performing block cipher-based encoding on the plurality of intermediate values to produce a plurality of intermediate random values, and an operation S1154 of producing the tag on the basis of a combination of the plurality of intermediate random values.

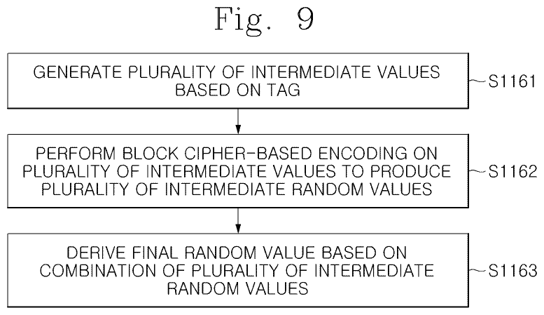

Furthermore, in the 2-1st authenticated encryption unit (=eGCM-SIV-1), the operation S116 may include, as shown in FIG. 9, an operation S1161 of generating a plurality of intermediate values on the basis of the tag, an operation S1162 of performing block cipher-based encoding on the plurality of intermediate values to produce a plurality of intermediate random values, and an operation S1163 of deriving a final random value on the basis of a combination of the plurality of intermediate random values.

Here, the parameters and components related to the 2-1st authenticated encryption unit (=eGCM-SIV-1) are summarized as follows.
k: Key bit length of a base block cipher.
n: Block bit length of a base block cipher.
w: Window parameter, a natural number used in the operation of the algorithm.
E: Base block cipher, which is not used in decryption, and E(K,M) represents the result of encrypting an n-bit block M with a k-bit key K.
H: Keyed function that has an element of [symbol] as a key, and receives an arbitrary-length bit string as input, and outputs an n-bit output.
GF(2ⁿ): Galois field with 2ⁿ elements. GF(2ⁿ) is defined as GF(2)/F(W) for an n-th order primitive polynomial F(W), where W may be represented as 2.

Accordingly, the 2-1st authenticated encryption unit (=eGCM-SIV-1) may receive, as input, hash keys

$${K}_{h} , {K}_{h}^{′} , {K}_{h}^{″} ∈ K ,$$

k-bit keys K,K′,K″, a nonce N of arbitrary bit length, plaintext M of arbitrary bit length, and associated data A of arbitrary bit length, and output ciphertext C and tag T.

Here, the associated data (AD) is data used for authentication along with the encrypted message but is not encrypted. Therefore, the associated data may be transmitted unencrypted and used to verify integrity and authentication.

More specifically, in the 2-1st authenticated encryption unit (=eGCM-SIV-1), the tag generation unit 430 may produce a tag T, as shown in Equation 9 below, by defining the key input as

$${K}_{f} = ( K , {K}^{′} , {K}_{h} , {K}_{h}^{′} ) ,$$

setting the nonce N, associated data A, and plaintext M as inputs, and setting the output length to 2n.

$$T = HteC ( {K}_{f} , ( N , A , M ) , 2 n ) \qquad [ Equation 9 ]$$

Next, the random number generation unit 450 may set the key input as K″, the message input as T, and the output length as |M|, thereby producing a key stream Z, as shown in Equation 10 below.

$$Z = eCTR ( {K}^{″} , T , \vert M \vert ) \qquad [ Equation 10 ]$$

Accordingly, the 2-1st authenticated encryption unit (=eGCM-SIV-1) may generate ciphertext C by adding plaintext M and Z, as shown in Equation 11 below.

$$C = M ⊕ Z \qquad [ Equation 11 ]$$

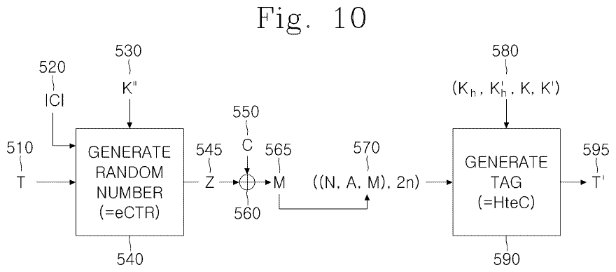

Furthermore, FIG. 10 illustrates a configuration in which the authenticated encryption apparatus 120 generates a random number using the first pseudo-random number function (=eCTR), performs decryption using the random number, and generates a tag using the second pseudo-random number function (=HteC) to perform authentication (=embodiment 2-2).

More specifically, as shown in FIG. 10, the authenticated encryption apparatus 120 may be configured to include a random number generation unit 540 and a tag generation unit 590 (hereinafter, the 2-2nd authentication decryption unit in FIG. 10 will be referred to as “eGCM-SIV-2”).

For example, the 2-2nd authentication decryption unit (=eGCM-SIV-2) may implement authenticated encryption, based on GCM-SIV, by generating a tag using the second pseudo-random number function (=HteC) and replacing the CTR block with the first pseudo-random number function (=eCTR), thereby enhancing security without compromising efficiency. However, the present disclosure is not necessarily limited thereto, and it may be implemented in various other structures.

More specifically, referring to FIG. 10, the 2-2nd authentication decryption unit (=eGCM-SIV-2) may generate the random number (Z of 545 in FIG. 10), based on a given tag (T of 510 in FIG. 10), in the operation S110 and produce plaintext (M of 565 in FIG. 10) for the given ciphertext (C of 550 in FIG. 10), based on the random number (Z of 545 in FIG. 10), in operation S120, thereby performing authentication, based on the tag calculation value (T′ of 595 in FIG. 10), produced based on the plaintext (M of 565 in FIG. 10), and the tag (T of 510 in FIG. 10).

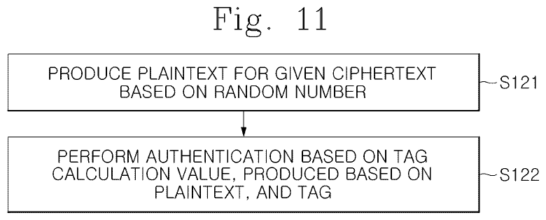

More specifically, in the 2-2nd authentication decryption unit (=eGCM-SIV-2), the operation S120 may include, as shown in FIG. 11, an operation S121 of producing plaintext for the given ciphertext, based on the random number, and an operation S122 of performing authentication, based on the tag calculation value, produced on the basis of the plaintext, and the tag.

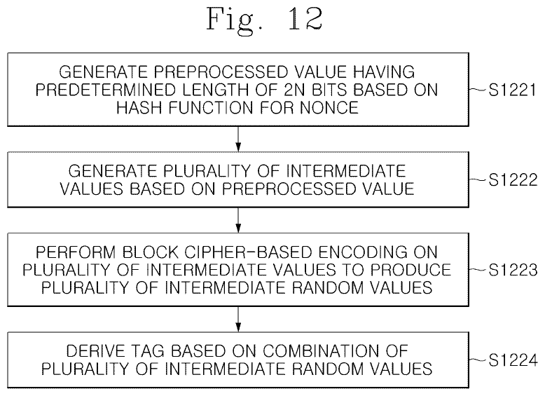

Here, as shown in FIG. 12, the operation S122 of performing authentication may include an operation S1221 of generating a preprocessed value having a predetermined length of 2n bits, based on a hash function for the nonce, an operation S1222 of generating a plurality of intermediate values, based on the preprocessed value, an operation S1223 of performing block cipher-based encoding on the plurality of intermediate values to produce a plurality of intermediate random values, and an operation S1224 of deriving the tag, based on a combination of the plurality of intermediate random values.

Additionally, in the producing operation S1223, v intermediate random values may be produced by performing block cipher-based encoding on the v intermediate values.

Additionally, the derivation operation S1224 may include an operation (not shown) of deriving u random value blocks, based on a combination of the v intermediate random values, and a final-random value derivation operation (not shown) of deriving a final random value having a length of s, based on the u random value blocks.

Furthermore, in the final-random value derivation operation (not shown), the final random value may be derived by extracting the bits having the length of s from the random value derived by concatenating the u random value blocks.

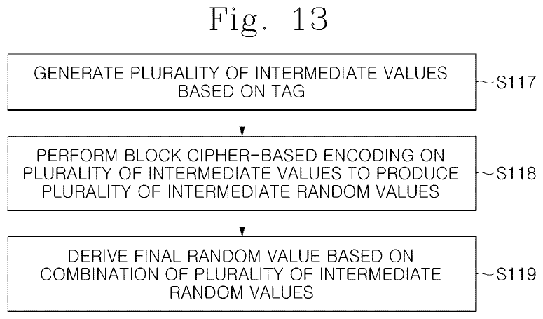

In addition, in the 2-2nd authentication decryption unit (=eGCM-SIV-2), the operation S110 may include, as shown in FIG. 13, an operation S117 of generating a plurality of intermediate values, based on the tag, an operation S118 of performing block cipher-based encoding on the plurality of intermediate values to produce a plurality of intermediate random values, and an operation S119 of deriving a final random value, based on a combination of the plurality of intermediate random values.

Additionally, in the 2-2nd authentication decryption unit (=eGCM-SIV-2), the operation S120 may include, as described in FIG. 8 above, an operation S1151 of generating a preprocessed value having a predetermined length of 2n bits, based on a hash function for the nonce, an operation S1152 of generating a plurality of intermediate values, based on the preprocessed value, an operation S1153 of performing block cipher-based encoding on the plurality of intermediate values to produce a plurality of intermediate random values, and an operation S1154 of generating the tag on the basis of a combination of the plurality of intermediate random values.

Furthermore, the parameters and components related to the 2-2nd authentication decryption unit (=eGCM-SIV-2) may refer to those of the 2-1st authenticated encryption unit (=eGCM-SIV-1) described above.

Accordingly, the 2-2nd authentication decryption unit (=eGCM-SIV-2) may receive, as input, hash keys

$${K}_{h} , {K}_{h}^{′} ∈ K ,$$

k-bit keys K,K′,K″, a nonce N of arbitrary bit length, ciphertext C of arbitrary bit length, a tag T, and associated data A of arbitrary bit length, and output plaintext M when authentication is successful, or ⊥ (authentication failure symbol) when authentication fails.

More specifically, in the 2-2nd authentication decryption unit (=eGCM-SIV-2), the random number generation unit 540 may set the key input as K″, the message input as T, and the output length as |C|, thereby producing a key stream Z, as shown in Equation 12 below.

$$Z = eCTR ( {K}^{″} , T , \vert M \vert ) \qquad [ Equation 12 ]$$

Next, the 2-2nd authentication decryption unit (=eGCM-SIV-2) may generate plaintext M by adding the ciphertext C and the produced Z, as shown in Equation 13 below.

$$M = C ⊕ Z \qquad [ Equation 13 ]$$

Next, the tag generation unit 590 may define the key input as

$${K}_{f} = ( K , {K}^{′} , {K}_{h} , {K}_{h}^{′} ) ,$$

as shown in Equation 14 below, and may then input the nonce N, associated data A, and message M, and set the output length to 2n, thereby producing a tag T′.

$${T}^{′} = HteC ( {K}_{f} , ( N , A , M ) , 2 n ) \qquad [ Equation 14 ]$$

Accordingly, the 2-2nd authentication decryption unit (=eGCM-SIV-2) may output a message M when the produced tag T′ and the given tag T are identical, and output an authentication failure symbol (⊥) when they are different (T≠T′).

Accordingly, the authenticated encryption method, apparatus, system, and computer program, providing enhanced security and extension of a nonce length, according to an embodiment of the present disclosure may provide extension of the nonce length to effectively prevent efficiency degradation and provide enhanced security while increasing the limit on the number of times encryption is performed, may effectively suppress nonce misuse while providing high security, may improve usability by reducing the need for key renewal, and may further provide nonce length extension or nonce misuse suppression functions, thereby effectively reducing additional management work and costs that may be required to prevent nonce misuse.

In this regard, the specific configuration and operation of the first pseudo-random number function (=eCTR) and the second pseudo-random number function (=HteC) according to an embodiment of the present disclosure will be described in detail below.

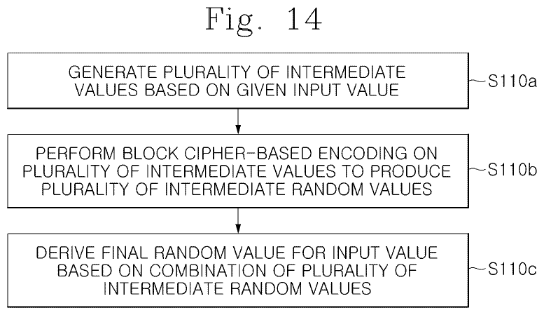

More specifically, FIG. 14 illustrates a flowchart illustrating the operation of the first pseudo-random number function (=eCTR) according to an embodiment of the present disclosure.

More specifically, as shown in FIG. 14, the operation of the first pseudo-random number function (=eCTR) in the present disclosure may include an operation S110a of generating a plurality of intermediate values, based on a given input value, an operation S110b of performing block cipher-based encoding on the plurality of intermediate values to produce a plurality of intermediate random values, and an operation S110c of deriving a final random value for the input value, based on a combination of the plurality of intermediate random values.

In this regard, FIG. 15 illustrates the detailed configuration and operation of the first pseudo-random number function (=eCTR) according to an embodiment of the present disclosure.

Here, referring to FIG. 15, the first pseudo-random number function (=eCTR) may include an encoding unit 620 and a randomization unit 640, and the encoding unit 620 may generate a plurality of intermediate values Y, based on an input 610 including an encryption key K of the block cipher, an input value X for generating a pseudo-random number, and a length s of the final random value ultimately obtained, and may provide an output 630 including the encryption key K of the block cipher and the length s of the final random value to the randomization unit 640.

Subsequently, the randomization unit 640 may derive a final random value Z 650 having a length s through a block cipher-based operation.

Therefore, the first pseudo-random number function (=eCTR) may efficiently generate random numbers with an arbitrary output length s and provide a highly secure pseudo-random number function (PRF).

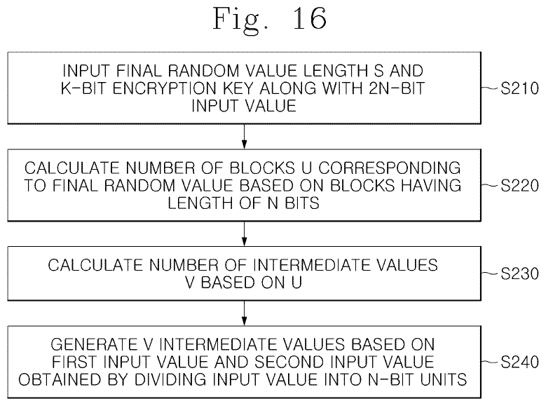

More specifically, FIG. 16 illustrates a detailed flowchart for the operation S110a.

As shown in FIG. 16, the operation S110a may include an operation S210 of receiving, along with the 2n-bit input value, the final random value length s and a k-bit encryption key.

More specifically, referring to FIGS. 15 and 16, the encoding unit 620 may receive the 2n-bit input value X, the final random value length s, and the k-bit block cipher encryption key K.

For example, when the input value X is an 8-bit value, such as “01101011,” then n is 4. When the final random value is 10 bits long, then s is 10. In addition, when the encryption key K used for the block cipher has 64 bits, then k may be 64.

Additionally, the operation of the first pseudo-random number function (=eCTR) may include an operation S220 of calculating the number of blocks u corresponding to the final random value, based on the block having a length of n bits, and an operation S230 of calculating the number of intermediate values v, based on u.

More specifically, in the operation S220, since the final random value has a length of s bits and the block has a length of n bits, the number of blocks u corresponding to the final random value may be the smallest integer value greater than or equal to s/n, as shown in Equation 15 below.

$$u = ⌈ \frac{s}{n} ⌉ \qquad [ Equation 15 ]$$

For example, when s is 10 and n is 4, u may be 3.

Next, in the operation S230, the number of intermediate values v is calculated based on u, and in this case, v may be the number of intermediate values required to produce u intermediate random values.

More specifically, as shown in Equation 16 below, v may be the value obtained by adding u to the smallest integer value greater than or equal to u/w.

$$v = ⌈ \frac{u}{w} ⌉ + u \qquad [ Equation 16 ]$$

Here, w is a window parameter, which may be the number of blocks included in a group when configuring a group by grouping blocks.

For example, when u is 3 and w is 2, v may be 5.

Next, in the operation S240, the v intermediate values are generated based on a first input value and a second input value, which are obtained by dividing the input value into n-bit units.

In this case, since the input value X has a length of 2n bits, the first and second input values may be produced by dividing it into n-bit units.

For example, if the input value X is an 8-bit value such as “01101011,” the first input value A may be “0110” and the second input value B may be “1011.”

Here, the first input value A and the second input value B may be encoded and implemented as elements of a Galois field (GF), wherein GF(2ⁿ) is a finite field with 2ⁿ elements and may be defined as GF(2)/F(W) for an n-th order primitive polynomial F(W), and hereinafter, a description will be made based on W represented as 2.

Therefore, in the operation S240, intermediate values Yi may be generated for i=1, . . . , 5(=v), and more specifically, based on Equation 17 below, five intermediate values Yi having a length of n bits may be produced.

$${Y}_{i} = A ⊕ {2}^{i - 1} \cdot B \qquad [ Equation 17 ]$$

Here, ⊕ represents a bitwise XOR, and 2 may correspond to W described above.

Therefore, for a more specific example, when the primitive polynomial F(W) of the Galois field is W⁴+W³+1, the first input value A is “0110,” and the second input value B is “1011,” Y1=A⊕B=“1101,” Y2=A⊕2-B=“0110”⊕(“1001”⊕“0110”)=“0110”⊕“1111”=“1001”, etc. may be produced.

Next, the encoding unit 620 may generate Y by concatenating the intermediate values Yi, as shown in Equation 18 below, and transmit it to the randomization unit 240 along with the block cipher encryption key K and the length s of the final random value.

$$Y = ( {Y}_{1} , … , {Y}_{v} ) \qquad [ Equation 18 ]$$

Next, in the operation S110b, block cipher-based encoding is performed on the plurality of intermediate values to produce a plurality of intermediate random values.

Here, in the operation S110b, block cipher-based encoding may be performed on the v intermediate values to produce v intermediate random values.

More specifically, the randomization unit 640 may decode Y into n-bit blocks to produce the plurality of intermediate values Yi, and then perform block cipher-based encoding on each i=1, . . . , 5 (=v), as shown in Equation 19 below, to produce a plurality of intermediate random values Y′ᵢ.

$${Y}_{i}^{′} = E ( K , {Y}_{i} ) \qquad [ Equation 19 ]$$

Here, E represents the encoder of the block cipher, and E(K, M) represents the result of encrypting an n-bit block M using a k-bit encryption key K based on the block cipher.

Next, in the operation S110c, a final random value for the input value is derived based on a combination of the plurality of intermediate random values.

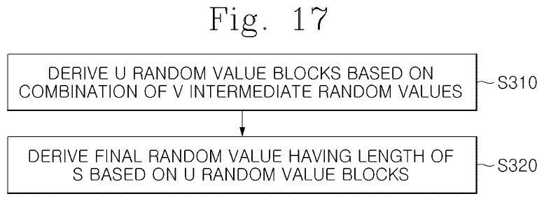

Regarding this, FIG. 17 illustrates a detailed flowchart for the operation S110c.

As shown in FIG. 17, the operation S110c may include an operation S310 of deriving the u random value blocks, based on a combination of the v intermediate random values.

More specifically, for each i=1, . . . , 3 (=u), qi may be the smallest integer value greater than or equal to i/w, as shown in Equation 20 below.

$${q}_{i} = ⌈ \frac{i}{w} ⌉ \qquad [ Equation 20 ]$$

In this case, in the operation S110c, u random value blocks Zi may be derived based on a combination of the five (=v) intermediate random values

$${Y}_{i}^{′} ,$$

as shown in Equation 21 below.

$${Z}_{i} = {Y}_{{q}_{i} \cdot ( w + 1 ) - w}^{′} ⊕ {Y}_{i + {q}_{i}}^{′} \qquad [ Equation 21 ]$$

Here,

$${Y}_{{q}_{i} \cdot ( w + 1 ) - w}^{′}$$

may be an intermediate random value corresponding to each group, and

$${Y}_{i + {q}_{i}}^{′}$$

may be an intermediate random value corresponding to each block. Accordingly, the random value block Zi may be derived by combining the intermediate random value corresponding to each group and the intermediate random value corresponding to each block.

In addition, the operation S110c may include a final-random value derivation operation S320 for deriving a final random value having a length of s, based on the u random value blocks.

In this case, in the operation S320, the final random value may be derived by extracting bits having the length of s from the random value derived by concatenating the u random value blocks.

More specifically, in the operation S320, the final random value Z may be produced by extracting a length (S bits) given according to a predetermined criterion, such as the initial s bits, from the random value derived by concatenating the u random value blocks Zi, as shown in Equation 22 below.

$$Z = first s - bit of {Z}_{1} ‖ … ‖ {Z}_{u} \qquad [ Equation 22 ]$$

Accordingly, assuming that the input is randomly selected in the present disclosure, the probability that an attacker [symbol] , who limits the total output length to σ-blocks, the maximum output length per call to [symbol] -blocks, and the number of calls to q, can successfully distinguish the pseudo-random number function (PRF) according to the present disclosure from the random number function may vary between ½ and at most

$$O ( \frac{{σ}^{2} w ℓ}{{2}^{2 n}} + \frac{σ w}{{2}^{n}} ) .$$

Therefore, the pseudo-random number function (PRF) according to the present disclosure may exhibit n-bit security, assuming that the message length limit is constant.

Furthermore, in the present disclosure, calculating w output blocks requires w+1 block cipher operations. Since setting w to a sufficiently large value (e.g., 24) is feasible, the amount of block cipher computation only increases by about 5% (based on w=24) compared to the existing CTR, ensuring high security while minimizing efficiency degradation.

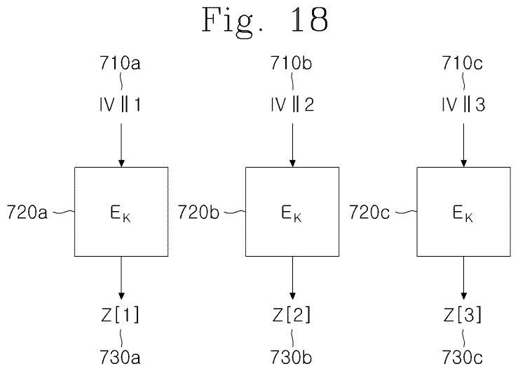

On the other hand, in the case of the pseudo-random number function according to the prior art, as shown in FIG. 18 illustrating the case where the first three blocks are calculated in CTR mode for the input IV, the computation of block cipher is performed once for each block while concatenating the block numbers with the input IV and inputting them into the block cipher, thereby significantly increasing the amount of block cipher computation and significantly reducing efficiency.

Furthermore, in the present disclosure, it is possible to implement the second pseudo-random number function (=HteC) by extending the first pseudo-random number function (=eCTR) to receive an input of arbitrary length and generate a pseudo-random number of arbitrary output length.

To this end, in the present disclosure, the operation S110a may further include a length preprocessing operation of generating the input value to have a predetermined length of 2n bits, based on a hash function for an unprocessed input value of arbitrary length.

More specifically, FIG. 18 illustrates a detailed flowchart for the preprocessing operation.

In this case, as shown in FIG. 18, the preprocessing operation may include an operation S410 of inputting an unprocessed input value and a first hash key and a second hash key, which are different from each other, to a first hash function that generates an output of n bits to produce a first hash output value and a second hash output value.

More specifically, referring to FIG. 20, the compression unit 830 may receive an unprocessed input value I 810 of arbitrary length, a k-bit block cipher encryption key K, and a first hash key Kₕ and a second hash keys Kₕ′ 820, which are different from each other.

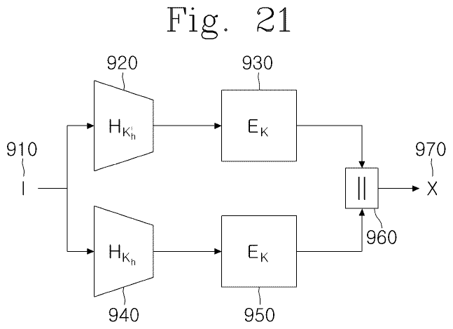

Accordingly, referring to FIG. 21, in the operation S410, an unprocessed input value I 910 may be input into a hash function H 940 along with a first hash key Kₕ to produce an n-bit first hash output value, and may also be input into a hash function H 920 along with a second hash key Kₕ′ to produce an n-bit second hash output value.

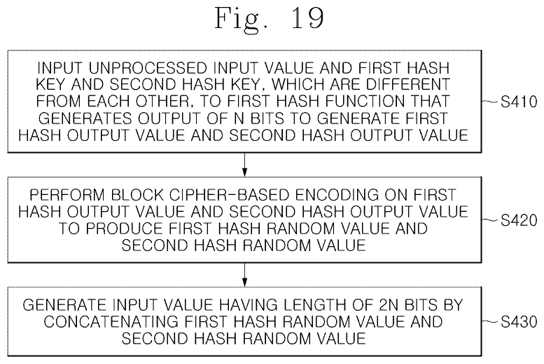

Furthermore, as shown in FIG. 19, the preprocessing operation may include an operation S420 of performing block cipher-based encoding on the first hash output value and the second hash output value to produce a first hash random value and a second hash random value.

More specifically, referring to FIG. 21, in the operation S420, block cipher-based encoding may be performed on the first hash output value 950 to produce a first hash random value, and block cipher-based encoding may be performed on the second hash output value 930 to produce a second hash random value.

Furthermore, as shown in FIG. 19, the preprocessing operation may include an operation S430 of concatenating the first hash random value and the second hash random value to generate an input value having a length of 2n bits.

More specifically, referring to FIG. 21, in the operation S430, the first hash random value and the second hash random value may be concatenated (960) to generate an input value X 970 having a length of 2n bits, and the input value X 970 having a length of 2n bits may be input to the first pseudo-random number function (=eCTR) to be used to generate a pseudo-random number having an arbitrary output length.

Accordingly, in the present disclosure, assuming that the hash function H is δ-AU and δ-AXU in the present disclosure, the probability that an attacker [symbol] , who limits the total output length to σ-blocks, the maximum output length per call to [symbol] -blocks, and the number of calls to q, can successfully distinguish the pseudo-random number function (PRF) according to the present disclosure from the random number function may vary between ½ and at most

$$O ( \frac{{σ}^{2} w ℓ}{{2}^{2 n}} + \frac{σ w}{{2}^{n}} + q δ + \frac{{σ}^{2} δ}{{2}^{n}} ) .$$

Therefore, the pseudo-random number function (PRF) according to the present disclosure may exhibit n-bit security, assuming that the message length limit is constant, i.e.,

$$δ = 0 ( \frac{1}{{2}^{n}} ) .$$

Furthermore, since the calculation of AU and AXU functions is generally more efficient than that of a block cipher, the efficiency of the pseudo-random number function (PRF) according to the present disclosure is most significantly affected by the efficiency of the encoding unit 220 and randomization unit 240. Therefore, the pseudo-random number function (PRF) according to the present disclosure may ensure high security while minimizing efficiency degradation.

Furthermore, a computer program according to another aspect of the present disclosure may be a computer program stored on a computer-readable medium to execute a series of steps of the authenticated encryption method, which provides enhanced security and extension of a nonce length, described above on a computer. The computer program may be not only a computer program including machine language codes created by a compiler, but also a computer program including high-level language codes executable in a computer using an interpreter or the like. In this case, the computer includes, in addition to a personal computer (PC) or a laptop computer, any type of information processing device equipped with a central processing unit (CPU) to execute a computer program, such as a server, a smartphone, a tablet PC, a PDA, or a mobile phone.

In addition, the computer-readable medium may be a medium that continuously stores a computer-executable program, or temporarily stores it for execution or download. In addition, the medium may be a variety of recording means or storage means in the form of a single piece of hardware or a combination of multiple pieces of hardware, and may not be limited to a medium directly connected to a computer system, but may also be distributed on a network. Therefore, the above detailed description should not be construed as limiting the disclosure in all respects and should be considered as examples. The scope of the present disclosure should be determined by a reasonable interpretation of the appended claims, and all changes within the equivalent scope of the disclosure are included in the scope of the disclosure.

In addition, an authenticated encryption apparatus for providing enhanced security and extension of a nonce length, according to an embodiment of the present disclosure, may include a processor; and a memory, wherein the memory may store instructions configured to cause, when executed by the processor, the apparatus to perform specific operations, the specific operations including: producing a plurality of intermediate values, based on a given input value; generating a random number, based on a combination of a plurality of intermediate random values produced by performing block cipher-based encoding on the plurality of intermediate values; and performing encryption or decryption, based on the random number.

Here, in the generating of the random number, the random number may be generated based on a given nonce of arbitrary length, and in the performing of the encryption, ciphertext and tag for given plaintext may be produced based on the random number.

In addition, in the generating of the random number, the random number may be generated based on a given nonce of arbitrary length, and in the performing of the decryption, plaintext may be produced using given ciphertext and tag, based on the random number.

In addition, the generating of the random number may include: generating a preprocessed value having a predetermined length of 2n bits, based on a hash function for the nonce; generating a plurality of intermediate values, based on the preprocessed value; performing block cipher-based encoding on the plurality of intermediate values to produce a plurality of intermediate random values; and deriving a final random value, based on a combination of the plurality of intermediate random values.

In addition, the generating of the random number may include: producing a tag, based on a given nonce of arbitrary length; and producing the random number, based on the tag, and in the performing of the encryption, ciphertext for given plaintext may be produced based on the random number.

In addition, the producing of the tag may include: generating a preprocessed value having a predetermined length of 2n bits, based on a hash function for the nonce; generating a plurality of intermediate values, based on the preprocessed value; performing block cipher-based encoding on the plurality of intermediate values to produce a plurality of intermediate random values; and producing the tag, based on a combination of the plurality of intermediate random values.

In addition, the producing of the random number may include: generating a plurality of intermediate values, based on the tag; performing block cipher-based encoding on the plurality of intermediate values to produce a plurality of intermediate random values; and deriving a final random value, based on a combination of the plurality of intermediate random values.

In addition, in the generating of the random number, the random number may be generated based on a given tag, and the performing of the decryption may include: producing plaintext for given ciphertext, based on the random number; and performing authentication, based on a tag calculation value, produced based on the plaintext, and the tag.

In addition, the generating of the random number may include: generating a plurality of intermediate values, based on the tag; performing block cipher-based encoding on the plurality of intermediate values to produce a plurality of intermediate random values; and deriving a final random value, based on a combination of the plurality of intermediate random values.

In addition, the performing authentication may include: generating a preprocessed value having a predetermined length of 2n bits, based on a hash function for the nonce; generating a plurality of intermediate values, based on the preprocessed value; performing block cipher-based encoding on the plurality of intermediate values to produce a plurality of intermediate random values; and deriving the tag, based on a combination of the plurality of intermediate random values.

In addition, the generating of the random number may include: receiving, along with the input value of 2n bits, a length s of the final random value and an encryption key of k bits; calculating the number of blocks u corresponding to the final random value, based on blocks having the length of n bits; calculating the number of intermediate values v, based on u; and generating the v intermediate values, based on a first input value and a second input value obtained by dividing the input value into n-bit units.

In addition, in the producing of the intermediate random values, v intermediate random values may be produced by performing block cipher-based encoding on the v intermediate values.

In addition, the deriving may include: deriving the u random value blocks, based on a combination of the v intermediate random values; and deriving a final random value having a length of s, based on the u random value blocks.

In addition, in the deriving of the final random value, the final random value may be derived by extracting bits having the length of s from a random value derived by concatenating the u random value blocks.

In addition, the generating of the random number may include generating the input value having a predetermined length of 2n bits, based on a hash function for an unprocessed input value of arbitrary length.

In addition, the generating of the input value may include: producing a first hash output value and a second hash output value by inputting the unprocessed input value, and a first hash key and a second hash key, which are different from each other, to a first hash function configured to generate an n-bit output; performing block cipher-based encoding on the first hash output value and the second hash output value to produce a first hash random value and a second hash random value; and generating the input value having a length of 2n bits by concatenating the first hash random value and the second hash random value.

Furthermore, FIG. 22 illustrates an apparatus 50 to which the proposed method of the present disclosure may be applied.

Referring to FIG. 22, the apparatus 50 may be configured to implement an authenticated encryption process that provides enhanced security and extension of a nonce length according to the proposed method of the present disclosure.

For example, the apparatus 50 to which the proposed method of the disclosure may be applied may include network devices such as repeaters, hubs, bridges, switches, routers, gateways, and the like, computer devices such as desktop computers, workstations, and the like, mobile terminals such as smartphones and the like, portable devices such as laptop computers and the like, home appliances such as a digital TV and the like, and vehicles such as an automobile and the like. As another example, the apparatus 50 to which the disclosure may be applied may be included as part of an ASIC (Application Specific Integrated Circuit) implemented in the form of an SoC (System-on-Chip).

The memory 20 may be connected to the processor 10 during operation, and may store programs and/or instructions for processing and controlling of the processor 10, and may store data and information used in the present disclosure, control information required for processing data and information according to the present disclosure, and temporary data generated during the data and information processing process. The memory 20 may be implemented as a storage device such as a ROM (Read-Only Memory), a RAM (Random Access Memory), an EPROM (Erasable Programmable Read-Only Memory), an EEPROM (Electrically Erasable Programmable Read-Only Memory), a flash memory, an SRAM (Static PAM), an HDD (Hard Disk Drive), an SSD (Solid State Drive), and the like.

The processor 10 may be operatively connected to the memory 20 and/or a network interface 30, and may control the operation of respective modules in the apparatus 50. In particular, the processor 10 may perform various control functions for performing the proposed method of the disclosure. The processor 10 may also be called a controller, a micro-controller, a micro-processor, a micro-computer, or the like. The proposed method of the disclosure may be implemented by hardware, firmware, software, or a combination thereof. When implementing the present disclosure using hardware, an ASIC (application specific integrated circuit) or a DSP (digital signal processor), a DSPD (digital signal processing device), a PLD (programmable logic device), an FPGA (field programmable gate array), or the like, configured to perform the present disclosure, may be provided in the processor 10. Meanwhile, when implementing the proposed method of the disclosure using firmware or software, the firmware or software may include instructions related to modules, procedures, or functions that perform functions or operations necessary for implementing the proposed method of the disclosure, and the instructions may be stored in the memory 20 or stored in a computer-readable recording medium (not shown) separate from the memory 20, and may be configured to cause, when executed by the processor 10, the apparatus 50 to perform the proposed method of the present disclosure.

In addition, the apparatus 50 may include a network interface device 30. The network interface device 30 may be connected to the processor 10 during operation, and the processor 10 may control the network interface device 30 to transmit or receive wireless/wired signals carrying information, data, signals, and/or messages through a wireless/wired network. The network interface device 30 may support various communication standards such as IEEE 802 series, 3GPP LTE(-A), 3GPP 5G, etc., and may transmit and receive control information and/or data signals according to the corresponding communication standards. The network interface device 30 may be implemented outside the apparatus 50 as needed.

The embodiments described in this specification and the attached drawings are merely exemplary and do not limit the scope of the present disclosure in any way. In addition, the connections or connection members between the components illustrated in the drawings are examples of functional connections and/or physical or circuit connections, and may be represented as various functional connections, physical connections, or circuit connections that are replaceable or addible in an actual device. In addition, unless specifically stated with “essential,” “important,” etc., the components may not be essential for the application of the present disclosure.

In the specification (especially, in the claims) of the disclosure, the term “said” and indicative terms similar thereto may be used for both a single element or multiple elements. In addition, if a range is stated in the present disclosure, it encompasses embodiments to which respective values within the range are applied (unless otherwise stated), and the respective values constituting the range are regarded as being described in the detailed description of the present disclosure. In addition, the steps presented in the method of the present disclosure are not intended to be restricted in their sequence, and the sequence thereof may be appropriately changed as needed, unless a certain step must precede according to the nature of the process. All examples or the use of exemplary terms (e.g., etc.) in the present disclosure is merely intended to describe the present disclosure in detail, and the scope of the present disclosure is not limited to the examples or exemplary terms, unless limited by the claims. In addition, those skilled in the art will understand that various modifications, combinations, and changes may be configured according to design conditions and elements without departing from the scope of the appended claims or their equivalents.

What is claimed is:

1. A method for performing authenticated encryption using a computing apparatus, the method comprising:
producing a plurality of intermediate values, based on a given input value;
generating a random number, based on a combination of a plurality of intermediate random values produced by performing block cipher-based encoding on the plurality of intermediate values; and
performing encryption or decryption, based on the random number.

2. The method of claim 1,
wherein, in the generating of the random number, the random number is generated based on a given nonce of arbitrary length, and
wherein, in the performing of the encryption, ciphertext and tag for given plaintext are produced based on the random number.

3. The method of claim 1,
wherein, in the generating of the random number, the random number is generated based on a given nonce of arbitrary length, and
wherein, in the performing of the decryption, plaintext is produced using given ciphertext and tag, based on the random number.

4. The method of claim 2,
wherein the generating of the random number comprises:
generating a preprocessed value having a predetermined length of 2n bits, based on a hash function for the nonce;
generating a plurality of intermediate values, based on the preprocessed value;
performing block cipher-based encoding on the plurality of intermediate values to produce a plurality of intermediate random values; and
deriving a final random value, based on a combination of the plurality of intermediate random values.

5. The method of claim 1,
wherein the generating of the random number comprises:
producing a tag, based on a given nonce of arbitrary length; and
producing the random number, based on the tag, and
wherein, in the performing of the encryption, ciphertext for given plaintext is produced based on the random number.

6. The method of claim 5,
wherein the producing of the tag comprises:
generating a preprocessed value having a predetermined length of 2n bits, based on a hash function for the nonce;
generating a plurality of intermediate values, based on the preprocessed value;
performing block cipher-based encoding on the plurality of intermediate values to produce a plurality of intermediate random values; and
producing the tag, based on a combination of the plurality of intermediate random values.

7. The method of claim 5,
wherein the producing of the random number comprises:
generating a plurality of intermediate values, based on the tag;
performing block cipher-based encoding on the plurality of intermediate values to produce a plurality of intermediate random values; and
deriving a final random value, based on a combination of the plurality of intermediate random values.

8. The method of claim 1,
wherein, in the generating of the random number, the random number is generated based on a given tag, and
wherein, the performing of the decryption comprises:
producing plaintext for given ciphertext, based on the random number; and
performing authentication, based on a tag calculation value, produced based on the plaintext, and the tag.

9. The method of claim 8,
wherein the generating of the random number comprises:
generating a plurality of intermediate values, based on the tag;
performing block cipher-based encoding on the plurality of intermediate values to produce a plurality of intermediate random values; and
deriving a final random value, based on a combination of the plurality of intermediate random values.

10. The method of claim 8,
wherein the performing authentication comprises:
generating a preprocessed value having a predetermined length of 2n bits, based on a hash function for the nonce;
generating a plurality of intermediate values, based on the preprocessed value;
performing block cipher-based encoding on the plurality of intermediate values to produce a plurality of intermediate random values; and
deriving the tag, based on a combination of the plurality of intermediate random values.

11. The method of claim 1,
wherein the generating of the random number comprises:
receiving, along with the input value of 2n bits, a length s of the final random value and an encryption key of k bits;
calculating the number of blocks u corresponding to the final random value, based on blocks having the length of n bits;
calculating the number of intermediate values v, based on u; and
generating the v intermediate values, based on a first input value and a second input value obtained by dividing the input value into n-bit units.

12. The method of claim 10,
wherein, in the producing of the intermediate random values, v intermediate random values are produced by performing block cipher-based encoding on the v intermediate values.

13. The method of claim 12,
wherein the deriving comprises:
deriving the u random value blocks, based on a combination of the v intermediate random values; and
deriving a final random value having a length of s, based on the u random value blocks.

14. The method of claim 13,
wherein, in the deriving of the final random value, the final random value is derived by extracting bits having the length of s from a random value derived by concatenating the u random value blocks.

15. The method of claim 1,
wherein the generating of the random number comprises
generating the input value having a predetermined length of 2n bits, based on a hash function, by preprocessing an unprocessed input value having an arbitrary length.

16. The method of claim 15,
wherein the preprocessing comprises:
producing a first hash output value and a second hash output value by inputting the unprocessed input value, and a first hash key and a second hash key, which are different from each other, to a first hash function configured to generate an n-bit output;
performing block cipher-based encoding on the first hash output value and the second hash output value to produce a first hash random value and a second hash random value; and
generating the input value having a length of 2n bits by concatenating the first hash random value and the second hash random value.

17. An apparatus for performing authenticated encryption, the apparatus comprising:
a processor; and
a memory,
wherein the memory stores instructions configured to cause, when executed by the processor, the apparatus to perform specific operations, the specific operations comprising:
producing a plurality of intermediate values, based on a given input value;
generating a random number, based on a combination of a plurality of intermediate random values produced by performing block cipher-based encoding on the plurality of intermediate values; and
performing encryption or decryption, based on the random number.

18. A computer-readable storage medium storing instructions configured to cause, when executed by a processor, an apparatus, comprising the processor and performing authenticated encryption, to perform specific operations,
wherein the specific operations comprise:
producing a plurality of intermediate values, based on a given input value;
generating a random number, based on a combination of a plurality of intermediate random values produced by performing block cipher-based encoding on the plurality of intermediate values; and
performing encryption or decryption, based on the random number.
